(19) United States
(12) Patent Application Publication
(10) Pub. No.: US 2009/0016150 A1
(43) Pub. Date: Jan. 15, 2009

(54) Ice cream and topping mixing attachment

(76) Inventor: Emile Mimran, Oakhurst, NJ (US)

Correspondence Address: EZRA SUTTON, P.A., PLAZA 9 BUILDING, 900 ROUTE 9 NORTH, WOODBRIDGE, NJ, 07095, US

(21) Appl. No.: 11/827,808

(22) Filed: Jul. 13, 2007

(51) Int. Cl. B01F 5/00; B01F 15/02

(52) U.S. Cl. 366/134

(57) ABSTRACT

An ice cream and topping mixing attachment for being detachably connected to a soft ice cream machine for the mixing of a topping with the soft ice cream. The mixing attachment includes a mixing attachment housing having an interior compartment with an interior side wall. The mixing attachment also includes a topping canister for containing topping which is supported in the interior compartment of the mixing attachment housing. The interior side wall of the interior compartment and the outer circular side wall of the topping canister form a vertical passageway for the ice cream to pass through from top to bottom. The topping canister includes an entrance canister upper end and an exit canister lower end. The canister lower end includes a valve thereon for expelling a topping ingredient from the topping canister. The mixing attachment housing also includes an entrance housing end and an exit housing end; the exit housing end of the mixing attachment housing and the valve on the exit canister lower end of the topping canister are co-extensive with each other and cooperate with each other for simultaneously expelling a composite of mixed soft ice cream and one or more topping ingredients from the exit housing end and from the valve on the exit canister lower end.

### FIELD OF THE INVENTION

The present invention relates to an ice cream and topping mixing attachment for an ice cream extruder. More particularly, this mixing attachment includes a detachable and disposable or re-useable canister having a prefilled topping chamber containing topping ingredients, such as sprinkles and syrups therein, for being attached to a soft ice cream extruder.

### BACKGROUND OF THE INVENTION

Ingredient feeders are well known in the art for use in various food processing applications in order to introduce one or more ingredients into a flowable base product. For example, ingredient feeders may be used to mix ingredients such as fruits, nuts, candies, or the like into base products such as ice cream, peanut butter, cake batter, pancake batter and the like. Typically, ingredient feeders are incorporated within the overall structure of a food processing apparatus, for example, a soft ice cream extruder apparatus. This makes such machines overly complex and complicated for maintenance, repair and changing of ingredients, as well as the cleaning of the interior ingredient feeder.

There remains a need for an improved ice cream and topping mixing attachment (ingredient feeder) that is disposable and has a fixed or detachable prefilled topping chamber containing topping ingredients (ie, sprinkles, pieces of chocolate, syrups, candy and the like) therein for being detachably connected to a soft ice cream extruder.

### DESCRIPTION OF PRIOR ART

Ingredient feeders, dispensing machines for soft-serve products and the like having various designs, structures, configurations and materials of construction have been disclosed in the prior art. For example, U.S. Pat. No. 5,743,639 to NORMAN discloses an ingredient feeder that meters a selected amount of an ingredient into a flowable food product including an enrobing chamber subtended by a blending tube. The blending tube houses an agitator assembly that moves the continuous flow of ingredient in both axial and radial directions as it mixes the ingredient with the flowable food product. The ingredient feeder can be used to introduce any ingredient which is in the form of generally solid or semi-solid pieces into any type of base product which is pumpable. In addition, the ingredient feeder includes a means which allows ingredients such as liquids and slurries to be introduced into the base product either separately or simultaneously with the substantially solid ingredients. Furthermore, the ingredient feeder is adapted to disperse the ingredient in the base product in a manner which prevents plugging and produces a consistent final product. The ingredient feeder is also easily adapted for applications having differing base product flow rates and is easily installed into existing production lines. This prior art patent does not disclose or teach the design, structure and configuration of the ice cream and topping mixing attachment of the present invention.

U.S. Pat. No. 6,145,701 to PUERNER et al. discloses a machine for dispensing a soft-serve product comprising a freezer barrel and a mix hopper for containing soft-serve mix. The mix hopper is in flow communication with the freezer barrel so that soft-serve mix can flow from the mix hopper into the freezer barrel. A flow passage is provided which leads from the freezer barrel to a draw spout. Also a beater assembly is provided for expelling frozen product from the freezer barrel via the flow passage to the draw spout. A solids hopper for containing a flowable solid topping is further provided, and an archimedes screw for feeding the solid topping from the solids hopper into the flow stream of soft-serve product as it passes through the flow passage. A vaned rotor and a rotation sensor meter the flow of soft-serve product through the flow passage and control the speed of a topping motor driving the archimedes screw. This prior art patent does not disclose or teach the design, structure and configuration of the ice cream and topping attachment of the present invention.

None of these prior art patents teach or disclose the structure and configuration of an ice cream and topping mixing attachment to an ice cream dispenser for dispensing a topping ingredient within the soft serve ice cream being dispensed from a soft serve ice cream machine that is easy to operate and use.

Accordingly, it is an object of the present invention to provide an ice cream and topping mixing attachment to an ice cream dispenser for dispensing a topping ingredient within the soft ice cream.

Another object of the present invention is to provide an ice cream and topping mixing attachment being detachable and disposable (made from plastic material) or reusable having a prefilled topping chamber containing topping ingredients therein which is detachably connected to a standard soft ice cream machine. Alternately, the topping chamber can be filled manually at the time of initiating the dispensing the soft ice cream.

Another object of the present invention is to provide an ice cream and topping mixing attachment that mixes and blends the topping ingredient and the soft ice cream within a mixing chamber and the mixed composite blend is then dispensed from a dispensing nozzle.

Another object of the present invention is to provide an ice cream and topping mixing attachment that uses an optional mixing blade to blend and/or twirl the topping ingredient and the soft ice cream together, and an optional molding (star mold) blade when dispensing the composite mixture.

Another object of the present invention is to provide an ice cream and topping mixing attachment that uses a topping ingredient selected from the group consisting of dried fruit pieces, crushed nuts, candy pieces, seeds, coconut flakes, miniature marshmallows, sprinkles, syrups, chocolate chips and the like.

Another object of the present invention is to provide an ice cream and topping mixing attachment that can be mass produced in an automated and economical manner and is readily affordable by the store owner and/or manufacturer.

### SUMMARY OF THE INVENTION

In accordance with the present invention, there is provided an ice cream and topping mixing attachment for being detachably connected to a soft ice cream machine for the mixing of a topping with the soft ice cream. The mixing attachment includes a mixing attachment housing having an interior compartment with an interior side wall. The mixing attachment housing has a connector member for detachably connecting the mixing attachment housing to a standard soft ice cream machine. The mixing attachment also includes a topping canister for containing topping which is supported in the interior compartment of the mixing attachment housing by a plurality of spaced-apart support members. Each of the support members includes a first end and a second end. Each of the first ends of the support members are attached to the interior side wall of the interior compartment and each of the second ends of the support members are attached or held in place to an outer circular side wall of the topping canister in order to centrally locate the topping canister within the interior compartment of the mixing attachment housing and in order to form an ice cream passageway therebetween. The topping canister includes an entrance canister upper end and an exit canister lower end. The canister lower end includes a valve thereon for expelling a topping ingredient from the topping canister. The mixing attachment housing also includes an entrance housing end and an exit housing end; the exit housing end of the mixing attachment housing and the valve on the exit canister lower end of the topping canister are supported co-extensively with each other and cooperate with each other for simultaneously expelling a composite of mixed soft ice cream and one or more topping ingredients from the exit housing end and from the valve on the exit canister lower end of the mixing attachment housing.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein:

FIG. 1 is a perspective view of the ice cream and topping mixing attachment device of the preferred embodiment of the present invention showing the major component parts thereto and in assembled state being readied for operational use;

FIG. 2 is an angled cross-sectional view of the ice cream and topping mixing attachment of the present invention showing an attachment housing, a plurality of support wings, a torpedo canister, a rubber one-way valve and a star shaping blade.

FIG. 2A is an enlarged cross-sectional view of the ice cream and topping mixing attachment device of the present invention showing the circular receiving slot opening on the mixing attachment housing receiving a circular tab member attached to the star shaping blade being fixed or removable;

FIG. 3 is an exploded perspective view of the ice cream and topping mixing attachment device of the present invention showing the attachment housing, the plurality of support wings connected to the torpedo canister, the rubber one-way valve, and the star blade;

FIG. 4 is an enlarged top plan view of the ice cream and topping mixing attachment device of the present invention showing the input end of the attachment for receiving soft ice cream therein;

FIG. 5 is an enlarged bottom plan view of the ice cream topping mixing attachment device of the present invention showing the output end of the attachment having a star blade thereon;

FIG. 6 is a cross-sectional view of the ice cream and topping mixing attachment device of the present invention taken along lines 6-6 of FIG. 1 in the direction of the arrows showing the attachment device in an assembled configuration and in an operational mode thereof; and

FIG. 7 is a top perspective view of the ice cream and topping mixing attachment device of the present invention showing an optional shaping blade having a geometrically-shaped opening in the form of a star.

### DETAILED DESCRIPTION OF PREFERRED EMBODIMENT 10

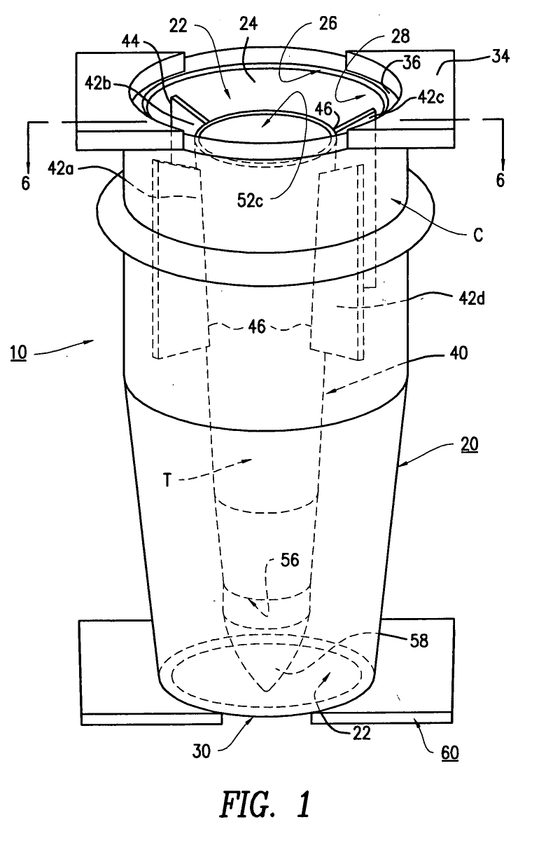

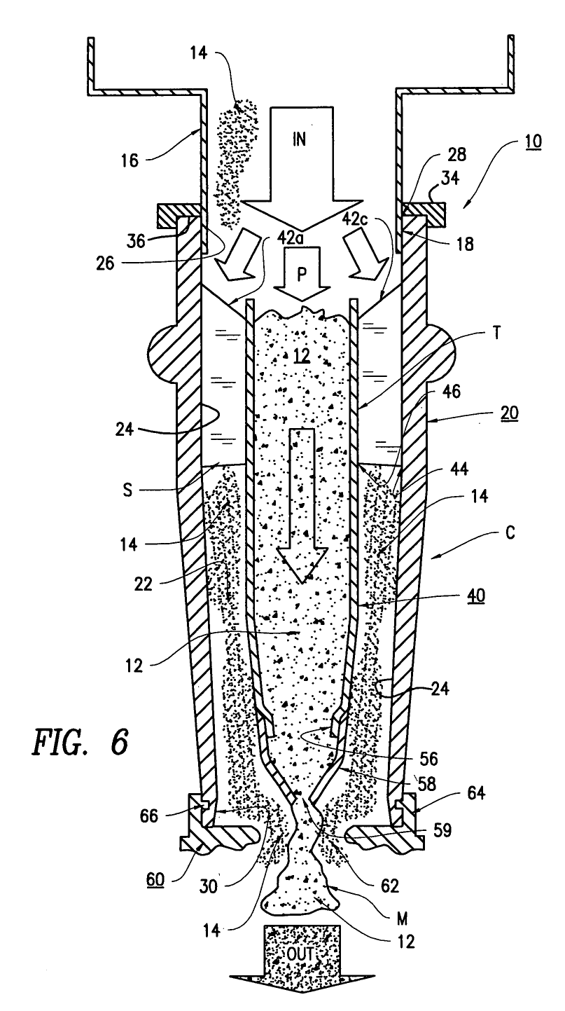

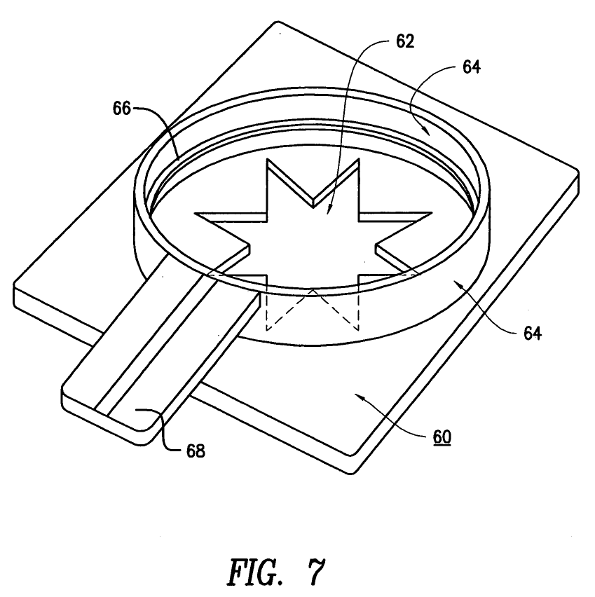

The ice cream and topping mixing attachment 10 and its component parts of the preferred embodiment of the present invention is represented in detail by FIGS. 1 through 7 of the patent drawings. The ice cream and topping mixing attachment device 10 is used for the mixing and blending of a topping ingredient 12 within soft ice cream 14 dispensed from a soft ice cream extrusion machine 16, as shown in FIG. 6 of the drawings.

As shown in FIGS. 1 through 6 of the drawings, the ice cream and topping mixing attachment device or ingredient mixing assembly 10 includes a mixing assembly housing 20 having an interior compartment 22 with an interior circular side wall 24. The mixing attachment housing 20 is substantially cylindrically-shaped (see FIG. 1). The mixing attachment housing 20 also includes a connector member 26 having an attachment lip member 34 for detachably connecting the mixing attachment housing 20 to the standard soft ice cream extrusion machine 16 (see FIG. 6). The mixing attachment housing 20 further includes an input housing end 28 and an exit housing end 30 having a slot opening 32. The input or entrance housing end 28 includes an attachment lip member 34 for detachably connecting to the sleeve nozzle opening 18 of the soft ice cream extrusion machine 16 (see FIG. 6). The adaptor attachment 10 also includes a washer-type seal 36 for connecting the attachment lip member 34 to the soft ice cream extrusion machine 16 (See FIGS. 1 and 6).

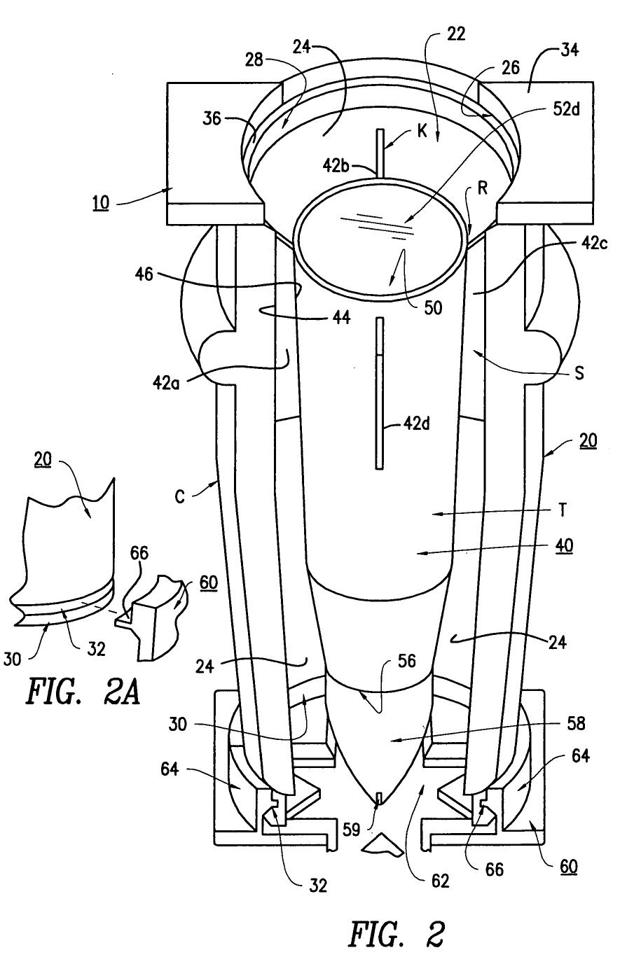

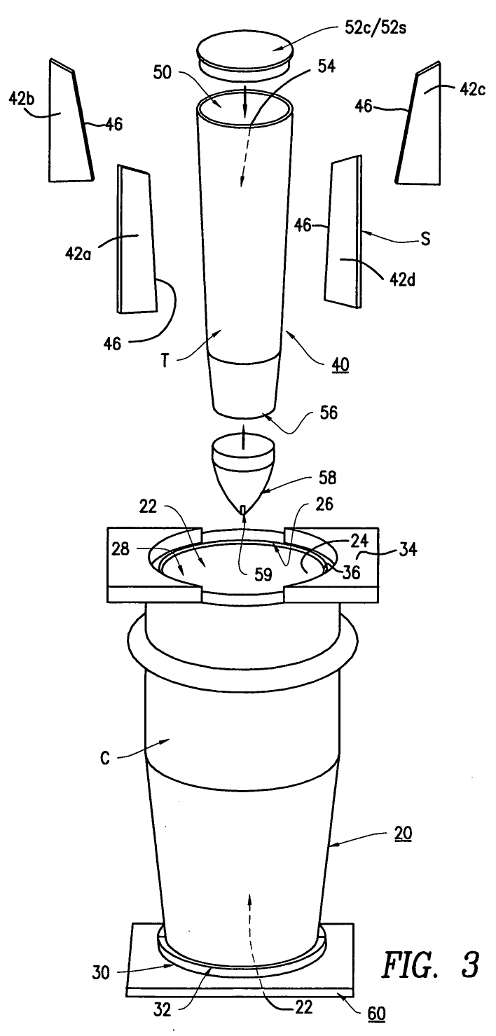

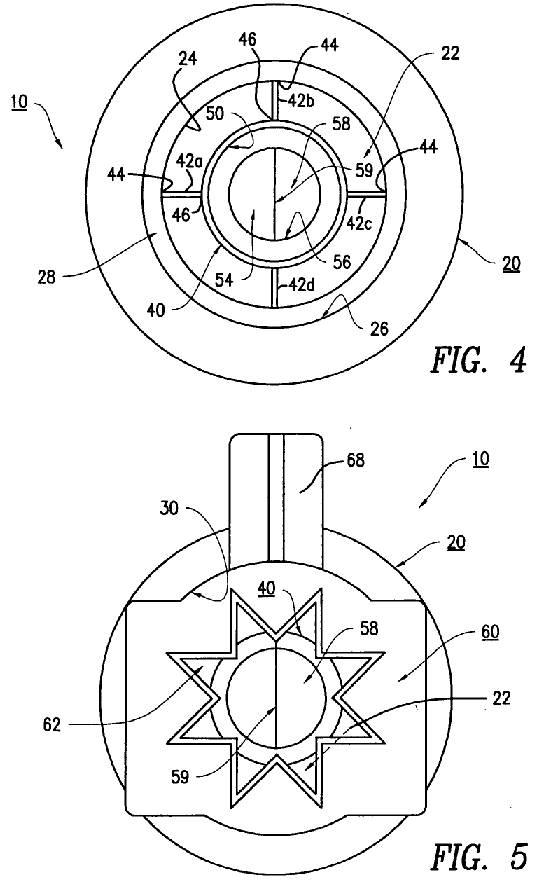

Additionally, the mixing attachment housing 20, includes a topping canister 40 being substantially torpedo-shaped T. The topping canister 40, as shown in FIGS. 3, 4 and 6, includes support means S within the interior compartment 22 of mixing attachment housing 20. The support means S as shown in FIGS. 2 to 4, includes a plurality of spaced-apart support members 42a, 42b, 42c and 42d being equally spaced-apart at 90° intervals (see FIGS. 2 and 4). Each of the support members 42a to 42d include a first end 44 and a second end 46. Each of the support members 42a and 42d are substantially trapezoidally-shaped R. Each of the first ends 44 of support members 42a to 42d are attached to the interior circular side wall 24 of the interior compartment 22 and each of the second ends 46 of support members 42a to 42d are attached to an outer circular side wall 48 of the torpedo-shaped topping canister 40 in order to centrally locate the topping canister 40 within the interior compartment 22 of the mixing attachment housing 20, as shown in FIGS. 2 to 4 of the patent drawings to form a vertical ice cream passageway 22 therebetween for the flow of soft ice cream 14 from the top to the bottom. Vertical edges 46 may be tapered at an angle of 70° to 80° so that canister 40 may be wedged in place as it is inserted into housing 20, as shown in FIGS. 1 and 2 of the drawings.

The torpedo-shaped topping canister 40 also includes an entrance canister end 50 for detachably connecting to a cap, a stopper member or a breakable disc 52c, 52s or 52d, respectively, and having a canister interior compartment 54. The torpedo-shaped topping canister 40 further includes an exit canister end 56 having a rubber one-way valve 58 thereon. The one-way valve 58 includes a slot opening 59, as depicted in FIG. 6, which is used for the expelling of a topping ingredient 12 from the topping canister 40. Topping ingredient 12 is selected from the group consisting of dried or hydrated fruit pieces, crushed nuts, candy pieces, seeds, coconut flakes, malt, miniature marshmallows, sprinkles, chocolate chips, syrups and the like and combinations thereof.

The exit housing end 30 of the mixing attachment housing 20 and the exist canister end 56 having the rubber one-way valve 58 thereon of topping canister 40, as shown in FIG. 6, are co-extensively mounted with each other and they cooperate with each other in order to expel a composite M of mixed ice cream and topping ingredients 12 from the exit housing end 30 and the exit canister end 56 simultaneously from the mixing attachment housing 20 of attachment 10.

Additionally, as shown in FIG. 7, the exit housing end 30 of the mixing attachment housing 20 includes an optional shaping blade 60 having a shaped opening 62 being detachably connected or fixed within the slot opening 32 of exit housing end 30 for shaping the soft ice cream and the topping ingredient composite M (see FIG. 6). The shaped opening 62 can be in the form of a star-shaped opening G (see FIG. 5) or other geometric shapes. Shaping blade 60 further includes a mounting support member 64 having a horizontal tab member 66 to be received within the circular slot opening 32 in order for the shaping blade 60 to be maintained on the exit housing end 30 of mixing attachment housing 20, as shown in FIG. 6 of the patent drawing. Additionally, shaping blade 60 also includes a handle member 68 for removing the shaping blade from the exit housing end 30 of mixing attachment housing 20. Optionally, shaping blade 60 is integrally connected to the exit housing end 30 of mixing attachment housing 20.

The mixing attachment housing 20, the torpedo-shaped toping canister 40 and the shaping blade 60 can be made from durable and rigid plastic materials or equivalents thereof. The mixing attachment housing 20, the torpedo-shaped topping canister 40 and the shaping blade 60 can be made from materials selected from the group consisting of durable plastic or rigid cardboard or metal, or other strengthened paper products. Therefore, attachment device 10 can be disposable or reusable depending upon the materials used in the construction of component parts 20, 40 and 60 of attachment device 10. After using the topping ingredient 12 within the topping canister 40, then the ingredient mixing assembly 10 can be discarded and disposed of in a convenient manner and replaced with another second ingredient mixing assembly 10 having another reservoir of the same or different topping ingredient 12 within the topping canister 40 of the ingredient mixing assembly 10 of the present invention.

In an alternate design, the plurality of support members 42a and 42d on the torpedo-shaped topping canister 40 can be detachably connected to the interior circular side wall 24 by connecting means K of mixing attachment housing 20. Connecting means K can be in the form of spaced-apart slidable sleeve channels (not shown) mounted to the interior circular side wall 24 of mixing attachment housing 20.

### OPERATION OF THE PRESENT INVENTION

As shown in FIGS. 1, 6 and 7 of the drawings, the ice cream and topping mixing attachment device 10 is pre-assembled with its major component parts in place which are the mixing attachment housing 20, the topping canister 40 having a rubber one-way valve 58 thereon, and the star-shaped shaping blade 60 (see FIGS. 2, 3, 6 and 7). Each of these component parts 20, 40, 58 and 60 may be manufactured by stamp molding and/or any other known method, and the component parts are assembled.

The canister interior compartment 54 of the torpedo-shaped topping canister 40 is prefilled with a topping ingredient 12 through the entrance canister end 50 before the top breakable disc 52d, or stopper member 52s, or the cap closure member 52c is attached to entrance canister end 50, as shown in FIGS. 2 and 3 of the drawings.

The ingredient mixing assembly 10 is now ready for operational use, where the user now removes the closure cap 52c, stopper member 52s or the breakable closure disc 52d from the entrance canister end or opening 50 to expose the topping ingredients 12 within the canister interior compartment 54 of the torpedo-shaped topping canister 40, as shown in FIGS. 2 and 6. In an alternate design, the breakable closure disc 52d can be made of an edible material/product that will break up and mix with the topping ingredients 12. Optionally, the disc 52d will slide down the canister interior compartment 54 when pressure P is exerted on the topping ingredients 12.

In the next step, the user attaches the attachment lip member 34 of the mixing attachment housing 20 to the threaded sleeve nozzle opening 18 of the soft ice cream extrusion machine 16 (see FIG. 6), such that the ingredient mixing assembly 10 is now in an operational mode for soft ice cream 14 and topping ingredient 12 dispensing. Optionally, the user can now attach the star-shaped shaping blade 60 to the exit housing end 30 of housing 20 for shaping the mixed soft ice cream and topping ingredient composite M, for producing a “swirl effect” on the composite M as it fills a cone or a cup.

In the next step, the operator turns ON the ice cream extrusion machine 16 to generate the soft ice cream 14 through the nozzle opening 18, as shown in FIG. 6. As the soft ice cream 14 fills the input housing end 28 of the mixing attachment housing 20, the soft ice cream 14 also fills the entrance canister end (opening) 50, such that the soft ice cream 14 creates a pressure P on the topping ingredients 12 (see FIG. 6) which then pushes the topping ingredients (sprinkles) through the canister interior compartment 54 of the torpedo-shaped topping canister 40. Simultaneously, the soft ice cream 14 proceeds through the vertical ice cream passageway 22 that surrounds the torpedo-shaped topping canister 40,such that the topping ingredient 12 escapes and exits the valve opening 59 of one-way valve 58. As shown in FIG. 6, the valve opening 59 and the exit housing end 30 are co-extensive and cooperate with each other in order to simultaneously expel a composite M of mixed soft ice cream and topping ingredient (see FIG. 6), as the composite M fills an ice cream cone or cup.

The aforementioned procedure continues until the operator stops the soft ice cream extrusion machine 16, such that only soft ice cream is expelled from valve opening 59 of one-way valve 58 and from the exit housing end 30. After using all of the topping ingredients 12 within topping canister 40, the user can discard the ingredient mixing assembly 10 and dispose of it in a conventional manner, and replace it with another second ingredient mixing assembly 10 having another reservoir of the same or different topping ingredient 12 within the topping canister 40 of the ingredient mixing assembly 10 of the present invention.

### ADVANTAGES OF THE PRESENT INVENTION

Accordingly, an advantage of the present invention is that it provides for an ice cream and topping mixing attachment for dispensing a topping ingredient within the soft ice cream.

Another advantage of the present invention is that it provides for an ice cream and topping mixing attachment being detachable and disposable or re-usable having a prefilled topping chamber containing topping ingredients therein which is detachably connected to a standard soft ice cream machine.

Another advantage of the present invention is that it provide an ice cream and topping mixing attachment that mixes and blends the topping ingredient and the soft ice cream within a mixing chamber and the mixed composite blend is then dispensed from a dispensing nozzle.

Another advantage of the present invention is that it provides an ice cream and topping mixing attachment that uses an optional mixing blade to blend the topping ingredient and the soft ice cream together, and an optional molding (star mold) blade when dispensing the composite mixture.

Another advantage of the present invention is that it provides for an ice cream and topping mixing attachment that uses a topping ingredient selected from the group consisting of dried fruit pieces, crushed nuts, candy pieces, seeds, coconut flakes, miniature marshmallows, sprinkles, syrups, chocolate chips and the like.

Another advantage of the present invention is that it provides for an ice cream and topping mixing attachment that can be mass produced in an automated and economical manner and is readily affordable by the store owner and/or manufacturer.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. An ice cream and topping mixing attachment for being detachably connected to a soft ice cream extrusion machine for the mixing of a topping with the soft ice cream, comprising:
a) a mixing attachment housing having an interior compartment and an interior side wall;
b) said mixing attachment housing having a connector member for detachably connecting said mixing attachment housing to a standard soft ice cream machine;
c) a topping canister for containing topping and being supported by support means in said interior compartment of said mixing attachment housing, said support means including a plurality of spaced-apart support members, each of said support members having a first end and a second end; said topping canister having an outer side wall;
d) each of said first ends of said support members being attached to said interior side wall of said interior compartment, and each of said second ends of said support members being attached to said outer side wall of said topping canister for supporting said topping canister within said interior compartment of said mixing attachment housing;
e) said interior side wall of said interior compartment and said outer side wall of said topping canister cooperate to form a vertical passageway therebetween for the soft ice cream to pass through said passageway as it moves from the top to the bottom;
f) said topping canister having an entrance canister upper end and an exit canister lower end; said exit canister lower end having a valve thereon for expelling the topping from said topping canister; and
g) said mixing attachment housing including an entrance housing end and an exit housing end; said exit housing end of said mixing attachment housing and said exit canister end of said topping canister are supported co-extensively with each other and cooperate with each other for simultaneously expelling a composite of mixed soft ice cream and one or more toppings from said exit housing end and from said valve on said exit canister lower end.

2. An ice cream and topping mixing attachment in accordance with claim 1, wherein said mixing attachment housing is substantially cylindrically-shaped.

3. An ice cream and topping mixing attachment in accordance with claim 1, wherein said topping canister is substantially torpedo-shaped.

4. An ice cream and topping mixing attachment in accordance with claim 1, wherein each of said support members are evenly spaced-apart about said topping canister and within said interior compartment.

5. An ice cream and topping mixing attachment in accordance with claim 1, wherein each of said support members are substantially trapezoidal in shape.

6. An ice cream and topping mixing attachment in accordance with claim 1, wherein said valve on said exit canister lower end of said torpedo-shaped topping canister is a rubber one-way valve.

7. An ice cream and topping mixing attachment in accordance with claim 1, wherein said exit housing end of said mixing attachment housing includes an optional shaping blade having a shaped opening being detachably connected within said exit housing end for shaping the soft ice cream.

8. An ice cream and topping mixing attachment in accordance with claim 7, wherein said shaped opening is in the form of a star-shaped opening.

9. An ice cream and topping mixing attachment in accordance with claim 1, wherein said topping canister includes topping ingredients selected from the group consisting of dried or hydrated fruit pieces, crushed nuts, candy pieces, seeds, coconut flakes, malt, miniature marshmallows, sprinkles, chocolate chips and the like, and combinations thereof.

10. An ice cream and topping mixing attachment in accordance with claim 1, wherein said mixing attachment housing is made from durable and rigid plastic materials.

11. An ice cream and topping mixing attachment in accordance with claim 1, wherein said mixing attachment housing is made from materials selected from the group consisting of durable plastic, or rigid cardboard, or metal, or other strengthened paper products.

12. An ice cream and topping mixing attachment in accordance with claim 1, wherein said topping canister is made from durable and rigid plastic materials.

13. An ice cream and topping mixing attachment in accordance with claim 1, wherein said exit housing end of said mixing attachment housing includes a shaping blade having a shaped opening being integrally connected within said exit housing end for shaping the soft ice cream.

14. An ice cream and topping mixing attachment in accordance with claim 1, wherein said entrance housing end includes an attachment lip member for detachably connecting to the sleeve nozzle opening of the soft ice cream extrusion machine.

15. An ice cream and topping mixing attachment in accordance with claim 5, wherein each of said support members includes a vertical edge.

16. An ice cream and topping mixing attachment in accordance with claim 15, wherein each of said vertical edges is tapered at an angle of 70° to 80° such that said torpedo-shaped topping canister is wedged in place as said topping canister is inserted into said mixing attachment housing.
